(19) United States
(12) Patent Application Publication
(10) Pub. No.: US 2017/0058189 A1
(43) Pub. Date: Mar. 2, 2017

(54) HIGH-PERFORMANCE ECO-FRIENDLY NON-EMULSIFIER

(71) Applicant: RHODIA OPERATIONS, Paris (FR)

(72) Inventors: Amit SEHGAL, Cherry Hill, NJ (US); Aaron LAU, Lower Gwynedd, PA (US); Thomas DECOSTER, Atascadero, CA (US)

(73) Assignee: RHODIA OPERATIONS, Paris (FR)

(21) Appl. No.: 15/248,396

(22) Filed: Aug. 26, 2016

Related U.S. Application Data
(60) Provisional application No. 62/210,189, filed on Aug. 26, 2015.

(51) Int. Cl. C09K 8/60; B01D 17/04; C09K 8/86

(52) U.S. Cl. CPC C09K 8/602; C09K 8/86; B01D 17/047

(57) ABSTRACT

A method for demulsifying an emulsion of oil and water including the step of contacting the emulsion with a composition that includes an amphoteric surfactant and a solvent. Demulsifying compositions are also provided.

### CROSS-REFERENCE TO RELATED APPLICATION

The present application claims the benefit of priority under 35 U.S.C. §119(e) of U.S. Provisional Application Ser. No. 62/210,189, filed on Aug. 26, 2015, the entire disclosure of which is incorporated herein by reference.

### BACKGROUND

Natural resources such as gas, oil, minerals, and water residing in subterranean formations can be recovered by drilling wells in the formations. Emulsions comprising oil and water commonly occur in the extraction, production, and processing and refining of oil. For example, as an aqueous fluid is forced into oil-bearing rock, the high shear could result in very viscous emulsions down hole that would impede flow-back and delay production. Non-emulsifiers are an essential component in fracturing fluids. They are added to prevent viscous oil-water emulsion formation and facilitate its rapid breakdown during hydraulic fracturing. An effective non-emulsifier can significantly enhance well recovery and facilitate quick production reducing down-time losses.

Non-emulsifiers are sold in a wide variety of formulations because their efficacy is dictated by the type of crude oil in the formation which can vary from well to well and for various applications and brines. Also, the quality of crude within a single producing well can vary from time to time. It is therefore extremely difficult to formulate a non-emulsifier composition that is effective in a broad range of crudes and for different brines with varying rock types (sandstone, limestone etc.). Current non-emulsifier formulations also largely do not have a favorable health, safety and environmental profile. Such formulations often contain formaldehyde resins or hazardous solvents like naptha (containing BTEX) or hazardous surfactant blends e.g. amines and quats.

Thus, there is a need for environmentally-friendly non-emulsifiers that are effective over a broad range of crudes for different rock types.

### SUMMARY

The present disclosure provides a method for demulsifying an emulsion of oil and water, wherein the method includes the steps of contacting the emulsion with an aqueous phase composition that includes an amphoteric surfactant and a solvent, wherein the combined concentration of the amphoteric surfactant and solvent ranges from greater than 0% to less than 1%, and demulsifying the emulsion. In an embodiment the composition further includes a non-ionic surfactant.

The present disclosure also provides a demulsifying composition for an emulsion of oil and water, wherein the composition includes a blend of at least one alcohol alkoxylate, an amphoteric surfactant, and a solvent.

Also provided is a demulsifying composition for an emulsion of oil and water, wherein the composition includes a blend of at least one alcohol alkoxylate, at least one anionic surfactant; an amphoteric surfactant; and a solvent.

In an embodiment, the amphoteric surfactant is selected from alkyl betaines and alkyl amido betaines. In an embodiment, the amphoteric surfactant is cocoamidopropyl betaine.

In an embodiment, the solvent includes an aromatic alcohol. In an embodiment, the solvent is benzyl alcohol.

In an embodiment, the non-ionic surfactant is selected from alcohol ethoxylates, alcohol propoxylates, and alcohol propoxylate ethoxylate copolymers.

In an embodiment, the emulsion is an oil-in-water emulsion. In an embodiment, the water phase is brine with dissolved salts or acid.

In an embodiment, the anionic surfactant is selected from mono and dialkyl phosphates and sulfosuccinates.

In an embodiment, the solvent includes at least one dibasic ester. In an embodiment, the dibasic ester is selected from dialkyl methylglutarate, dialkyl adipate, dialkyl ethylsuccinate, dialkyl succinate, dialkyl glutarate, and combinations thereof.

### DETAILED DESCRIPTION

The present disclosure provides compositions and methods for demulsifying emulsions of oil and water. As used herein the term “demulsify” means to partially or completely break down (an emulsion) into separate substances. In general, demulsifying compositions according to the present disclosure include an amphoteric surfactant and a solvent. In an embodiment, the emulsion is an oil-in-water emulsion.

In an embodiment, the amphoteric surfactant is selected from alkyl betaines and alkyl amido betaines. In another embodiment, the amphoteric surfactant is cocoamidopropyl betaine.

In an embodiment, the solvent is partially water soluble. In another embodiment, the solvent includes an alcohol. In an embodiment, the alcohol is an aromatic alcohol. In another embodiment, the solvent is benzyl alcohol.

In an embodiment, the method includes the step of contacting an emulsion of oil and water with an aqueous phase composition that includes an amphoteric surfactant and a solvent and demulsifying the emulsion. In an embodiment, the water phase is brine with dissolved salts or acid. In an embodiment, the concentration of the demulsifying composition ranges from greater than zero to less than 1%. In another embodiment, the composition further includes a non-ionic surfactant.

The present disclosure also provides a demulsifying composition for an emulsion of oil and water, wherein the composition includes at least one non-ionic surfactant, at least one amphoteric surfactant, and at least one solvent.

In an embodiment, the non-ionic surfactant includes one or more alcohol alkoxylates. In an embodiment, the alcohol alkoxylate is selected from one or more branched alcohol alkoxylates, one or more linear alcohol alkoxylates or a combination of one or more branched alcohol alkoxylates and one or more linear alcohol alkoxylates. In an embodiment, the alcohol alkoxylate is selected from alcohol ethoxylates, alcohol propoxylates, and alcohol propoxylate ethoxylate copolymers.

In certain embodiments, the composition includes a blend of at least one alcohol alkoxylate, at least one anionic surfactant, an amphoteric surfactant, and a solvent.

The anionic surfactant includes but is not limited to linear alkylbenzene sulfonates, alpha olefin sulfonates, paraffin sulfonates, alkyl ester sulfonates, alkyl sulfates, alkyl alkoxy sulfates, alkyl sulfonates, alkyl alkoxy carboxylates, alkyl alkoxylated sulfates, monoalkyl phosphates, dialkyl phosphates, sarcosinates, sulfosuccinates, isethionates, and taurates, as well as mixtures thereof. Commonly used anionic surfactants that are suitable as the anionic surfactant component of the composition of the present invention include, for example, ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium-monoalkyl phosphates, sodium dialkyl phosphates, sodium lauroyl sarcosinate, lauroyl sarcosine, cocoyl sarcosine, ammonium cocyl sulfate, ammonium lauryl sulfate, sodium cocyl sulfate, sodium trideceth sulfate, sodium tridecyl sulfate, ammonium trideceth sulfate, ammonium tridecyl sulfate, sodium cocoyl isethionate, disodium laureth sulfosuccinate, sodium dioctyl sulfosuccinate, sodium methyl oleoyl taurate, sodium laureth carboxylate, sodium trideceth carboxylate, sodium lauryl sulfate, potassium cocyl sulfate, potassium lauryl sulfate, monoethanolamine cocyl sulfate, sodium tridecyl benzene sulfonate, and sodium dodecyl benzene sulfonate.

In an embodiment, the solvent includes one or more dibasic esters. The one or more dibasic esters can be prepared by any appropriate process. For example, a process for preparing the adduct of adipic acid and of fusel oil is, for example, described in the document “The Use of Egyptian Fusel Oil for the Preparation of Some Plasticizers Compatible with Polyvinyl Chloride”, Chuiba et al., Indian Journal of Technology, Vol. 23, August 1985, pp. 309-311.

In an embodiment, the one or more dibasic esters are obtained by a process that includes an “esterification” stage by reaction of a diacid of formula HOOC-A-COOH or of a diester of formula MeOOC-A-COOMe with a branched alcohol or a mixture of alcohols. The reactions can be appropriately catalyzed. Use is preferably made of at least 2 molar equivalents of alcohols per diacid or diester. The reactions can, if appropriate, be promoted by extraction of the reaction by-products and followed by stages of filtration and/or of purification, for example by distillation.

The diacids in the form of mixtures can in particular be obtained from a mixture of dinitrile compounds in particular produced and recovered in the process for the manufacture of adiponitrile by double hydrocyanation of butadiene. This process, used on a large scale industrially to produce the greater majority of the adiponitrile consumed worldwide, is described in numerous patents and works. The reaction for the hydrocyanation of butadiene results predominantly in the formulation of linear dinitriles but also in formation of branched dinitriles, the two main ones of which are methylglutaronitrile and ethylsuccinonitrile. The branched dinitrile compounds are separated by distillation and recovered, for example, as top fraction in a distillation column, in the stages for separation and purification of the adiponitrile. The branched dinitriles can subsequently be converted to diacids or diesters (either to light diesters, for a subsequent transesterification reaction with the alcohol or the mixture of alcohols or the fusel oil, or directly to diesters). For example, the blend of dibasic esters is derived or taken from the methylglutaronitrile product stream in the manufacture of adiponitrile.

The one or more dibasic esters may be derived from one or more by-products in the production of polyamide, for example, polyamide 6,6. In one embodiment, the dibasic esters include a blend of linear or branched, cyclic or noncyclic, C₁-C₂₀ alkyl, aryl, alkylaryl or arylalkyl esters of adipic diacids, glutaric diacids, and succinic diacids. In another embodiment, the dibasic esters include a blend of linear or branched, cyclic or noncyclic, C₁-C₂₀ alkyl, aryl, alkylaryl or arylalkyl esters of adipic diacids, methylglutaric diacids, and ethylsuccinic diacids.

Generally, polyamide is a copolymer prepared by a condensation reaction formed by reacting a diamine and a dicarboxylic acid. Specifically, polyamide 6,6 is a copolymer prepared by a condensation reaction formed by reacting a diamine, typically hexamethylenediamine, with a dicarboxylic acid, typically adipic acid.

In one embodiment, the blend of dibasic esters can be derived from one or more by-products in the reaction, synthesis and/or production of adipic acid utilized in the production of polyamide, the dibasic ester composition comprising a blend of dialkyl esters of adipic diacids, glutaric diacids, and succinic diacids. In one embodiment, a blend of esters is derived from by-products in the reaction, synthesis and/or production of hexamethylenediamine utilized in the production of polyamide, typically polyamide 6,6. In one embodiment, a blend of dibasic esters is derived or taken from the methylglutaronitrile product stream in the manufacture of adiponitrile; the blend includes dialkyl esters of methylglutaric diacids, ethylsuccinic diacids and, optionally, adipic diacids.

In an embodiment, the boiling point of the one or more dibasic esters ranges from about 120° C. to about 450° C. In one embodiment, the boiling point of the one or more dibasic esters ranges from about 160° C. to about 400° C.; in one embodiment, the range is from about 210° C. to about 290° C.; in another embodiment, the range is from about 210° C. to about 245° C.; in another embodiment, the range is from about 215° C. to about 225° C. In one embodiment, the boiling point range is from about 210° C. to about 390° C., more typically from about 280° C. to about 390° C., more typically from about 295° C. to about 390° C. In one embodiment, boiling point is from about 215° C. to about 400° C., typically from about 220° C. to about 350° C.

In one embodiment, the boiling point of the one or more dibasic esters ranges from about 300° C. to about 330° C. In another embodiment, the boiling point range of the one or more dibasic esters ranges from about 295° C. to about 310° C.

In other embodiments, the composition includes a blend of at least one alcohol alkoxylate, an amphoteric surfactant, and a solvent. In an embodiment, the composition includes an alcohol alkoxylate, a betaine amphoteric surfactant, and a partially water soluble solvent. In certain embodiments, the partially water soluble solvent is an alcohol.

While specific embodiments are discussed, the specification is illustrative only and not restrictive. Many variations of this disclosure will become apparent to those skilled in the art upon review of this specification.

Unless defined otherwise, all technical and scientific terms used herein have the same meaning as is commonly understood by one of skill in the art to which this specification pertains.

As used in the specification and claims, the singular form “a”, “an” and “the” includes plural references unless the context clearly dictates otherwise.

As used herein, and unless otherwise indicated, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

The present disclosure will further be described by reference to the following examples. The following examples are merely illustrative and are not intended to be limiting. Unless otherwise indicated, all percentages are by weight of the total composition.

### EXAMPLES

### Example 1

### Amphoteric Surfactants as Non-Emulsifiers

Performance of various amphoteric surfactants as non-emulsifiers was tested. In each test, 4 mL of surfactant or surfactant in solvent was combined with a brine (15% HCl) and 4 mL of Texas Sweet crude oil in a 12 mL test tube. A control sample containing just brine and crude oil was also tested. Test tubes containing the test or control samples were mixed on a wrist action shaker (12 position) for 2 hours. Oil-water separation was monitored over time (% separation of aqueous phase). The results of amphoterics tested at 1 GPT and 2 GPT in 15% HCl are shown in Table 1. Fatty acid amidopropyl betaine, cocamidopropyl betaine, and butylether hydroxypropyl sultaine were able to break oil-water emulsions effectively.

In separate tests, cocamidopropyl betaine was combined with benzyl alcohol as a co-solvent. Non-emulsification performance of this combination was tested with various amounts of benzyl alcohol using the above-described protocol. As shown in Table 1, cocamidopropyl betaine with benzyl alcohol exhibited surprisingly improved non-emulsification performance in comparison with surfactant-only non-emulsifier compositions.

TABLE 1

| | Oil/Water Separation | | |
|---|---|---|---|
| | (%) in 15% HCl | | |
| Formulation | Control | 1 GPT | 2 GPT |
| J557 (Fatty acid amidopropyl betaine) | 0 | >50 | >75 |
| Mackam 35 (Cocamidopropyl betaine) | 0 | >75 | >75 |
| Mirataine ASC (Butylether | 0 | >75 | >75 |
| hydroxypropyl sultaine) | | | |
| Mackam CB-35 (coco betaine) | 0 | >75 | >75 |
| Mackam LAB (Lauryl betaine) | 0 | >75 | >75 |
| Miranol JBS (Disodium | 0 | 0 | 0 |
| capryloampho dipropionate) | | | |
| 20% Mackam 35 + 10% Benzyl Alc. | 0 | >90 | — |
| 20% Mackam 35 + 20% Benzyl Alc. | 0 | >90 | — |
| 20% Mackam 35 + 30% Benzyl Alc. | 0 | >90 | — |

### Comparative Example 1

### Compositions Without Amphoteric Surfactant and Solvent

Compositions A and B were prepared without amphoteric surfactants or alcohol solvents:

| Composition A | | Composition B | |
|---|---|---|---|
| Pentex ® 99 | 11.5 | Marconol ® SP-77 L | 37 |
| Rhodiasolv ® Infinity | 9 | Rhodasurf ® BC-840 (%) | 13 |
| Marconol ® 113 (%) | 3.5 | Water (%) | 50 |
| Rhodasurf ® BC-840 (%) | 13 | | |
| Water (%) | 63 | | |

Pentex® 99 (now known as Geropon 99) is a sodium dioctyl sulfosuccinate with a small amount of propylene glycol, 2-ethylhexanol, and isopropyl alcohol. Rhodiasolv® Infinity is a blend of diester solvents (dimethyl methylglutarate, dimethyl ethylsuccinate and dimethyl adipate), with surfactants Rhodasurf® DA-630 (isodecyl alcohol ethoxylate) and Rhodoclean® EFC (terpene EO/PO with polyethyleneglycol). Marconol® 113 is short ethoxylated alcohol. Rhodasurf® BC-840 is a non-ionic surfactant that is an ethoxylated tridecyl alcohol. Marconol SP-77 L is a proprietary alcohol oxyalkylate blend containing C6 ethoxylate-EO, Marconol® 113, 2-ethylhexanol, and C-18-25 alkoxylate (PO/EO).

Minor issues were observed with both compositions such as oil wetting in Composition A, in CaCl₂ on limestone and stability in Composition B at 10 GPT in KCl.

### Example 2

### Broad Spectrum Non-Emulsifiers

Compositions C and D were prepared:

| Composition C | | Composition D | |
|---|---|---|---|
| (final blend contains | | (final blend contains | |
| approximately 36.3% | | approximately 50% | |
| actives and 63.7% water) | | actives and 50% water) | |
| Pentex ® 99 | 8.1 | Marconol ® SP-77 L | 58.8 |
| Rhodiasolv ® | 6.6 | | (50% |
| Infinity (%) | | | actives) |
| Marconol ® 113 (%) | 1.0 | Mackam ® 35 (%) | 29.4 |
| Mackam ® 35 (%) | 29.4 | | (30% |
| | (30% | | actives) |
| | actives) | Benzyl Alcohol (%) | 5.9 |
| Benzyl Alcohol (%) | 5.9 | Rhodasurf ® | 5.9 |
| Rhodasurfp BC-840 (%) | 5.9 | BC-840 (%) | |
| Water (%) | 43.1 | | |

Compositions C and D were evaluated for non-emulsification performance with a range of crude oils according to the protocol in Example 1 in 15% HCl or 2% KCl brine at a use concentration of 2 gpt. Mackam® 35 is a cocamidopropyl betaine. As shown in Table 2, compositions containing cocamidopropyl betaine and benzyl alcohol demonstrated effective, broad spectrum non-emulsification performance in HCl and KCl brines over a wide range of crude oils.

TABLE 2
Oil/Water Separation (%) in 15% HCl

| | Composition | Composition | Composition | Composition |
|---|---|---|---|---|
| | C | C | D | D |
| | (15% HCl) | (2% KCl) | (15% HCl) | (2% KCl) |
| Control | 0 | <25 | 0 | <25 |
| (No non- | | | | |
| emulsifier) | | | | |
| Maverick | >90 | >90 | — | — |
| Canyon sand | >90 | >90 | >90 | >90 |
| Wolfcamp | >90 | >90 | >90 | >90 |
| Clearfork | >90 | >90 | >90 | >90 |
| Sprayberry | >90 | >90 | >90 | >90 |
| Cline Shale | 0 | >90 | 0 | >90 |
| N. Texas | >90 | >90 | >90 | >90 |
| Bakken | >90 | — | — | — |
| TX. Sweet | >75 | >90 | >75 | >90 |
| Troika | >90 | >90 | >90 | >90 |

Phase stability tests were also conducted on Composition D in 2% KCl, 5% NH₄Cl, and 15% HCl at 10 gpt. All three solutions were found to be phase stable over 25 hours at room temperature.

Wettability tests on Compositions C and D were also conducted. Composition C showed no staining (water wet) in all brines (2% KCl, 3% CaCl₂ at pH 2, and 15% HCl) on sandstone while staining oil-wet with limestone in 2% KCl and 3% CaCl₂ at pH 2. Composition D showed no staining (water wet) for limestone and sandstone for all brines tested.

The disclosed subject matter has been described with reference to specific details of particular embodiments thereof. It is not intended that such details be regarded as limitations upon the scope of the disclosed subject matter except insofar as and to the extent that they are included in the accompanying claims.

Therefore, the exemplary embodiments described herein are well adapted to attain the ends and advantages mentioned as well as those that are inherent therein. The particular embodiments disclosed above are illustrative only, as the exemplary embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the exemplary embodiments described herein. The exemplary embodiments described herein illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components, substances and steps. As used herein the term “consisting essentially of” shall be construed to mean including the listed components, substances or steps and such additional components, substances or steps which do not materially affect the basic and novel properties of the composition or method. In some embodiments, a composition in accordance with embodiments of the present disclosure that “consists essentially of” the recited components or substances does not include any additional components or substances that alter the basic and novel properties of the composition. If there is any conflict in the usages of a word or term in this specification and one or more patent or other documents that may be incorporated herein by reference, the definitions that are consistent with this specification should be adopted.

We claim:

1. A method for demulsifying an emulsion of oil and water, the method comprising: contacting the emulsion with an aqueous phase composition comprising an amphoteric surfactant and a solvent, wherein the combined concentration of the amphoteric surfactant and solvent ranges from greater than 0% to less than 1%, and demulsifying the emulsion.

2. The method of claim 1, wherein the composition further comprises a non-ionic surfactant.

3. The method of claim 1, wherein the amphoteric surfactant is selected from the group consisting of alkyl betaines and alkyl amido betaines.

4. The method of claim 1, wherein the amphoteric surfactant is cocoamidopropyl betaine.

5. The method of claim 1, wherein the solvent comprises an aromatic alcohol.

6. The method of claim 5, wherein the solvent is benzyl alcohol.

7. The method of claim 2, wherein the non-ionic surfactant is selected from the group consisting of alcohol ethoxylates, alcohol propoxylates, and alcohol propoxylate ethoxylate copolymers.

8. The method of claim 1, wherein the emulsion is an oil-in-water emulsion.

9. The method of claim 1, wherein the water phase is brine with dissolved salts or acid.

10. A demulsifying composition for an emulsion of oil and water, the composition comprising a blend of at least one alcohol alkoxylate, an amphoteric surfactant, and a solvent.

11. The composition of claim 10 further comprising at least one anionic surfactant.

12. The composition of claim 11, wherein the anionic surfactant is selected from the group consisting of mono or dialkyl phosphates and sulfosuccinates.

13. The composition of claim 10, wherein the solvent comprises at least one dibasic ester.

14. The composition of claim 13, wherein the dibasic ester is selected from the group consisting of dialkyl methylglutarate, dialkyl adipate, dialkyl ethylsuccinate, dialkyl succinate, dialkyl glutarate, and combinations thereof.

15. The composition of claim 10, wherein the amphoteric surfactant is selected from the group consisting of alkyl betaines and alkyl amido betaines.

16. The composition of claim 10, wherein the solvent comprises an aromatic alcohol.
